(19) United States
(12) Patent Application Publication
(10) Pub. No.: US 2018/0121602 A1
(43) Pub. Date: May 3, 2018

(54) OPTIMIZED PRESENTATION OF DATA RELATED TO IMAGING DEVICES AND USERS

(71) Applicant: Vladyslav Ukis, Nurnberg (DE)

(72) Inventor: Vladyslav Ukis, Nurnberg (DE)

(21) Appl. No.: 15/336,612

(22) Filed: Oct. 27, 2016

(51) Int. Cl. G06F 19/00; G06T 11/20; G06F 3/0484

(52) U.S. Cl. CPC G06F 19/321; G06F 3/04842; G06T 11/206

(57) ABSTRACT

In order to present medical information to a user in an easily consumed manner, a method and a system for identifying data to be displayed to a user are provided. Connections between users and devices are stored by a memory. The users are associated with first properties, and the devices are associated with second properties. A processor in communication with the memory identifies a first connection and a second connection from the stored connections based on the user. The data to be displayed to the user is identified based on the identified first connection, the identified second connection, or the identified first connection and the identified second connection.

### FIELD

The present embodiments relate to identifying data related to imaging devices and/or users and presenting the identified data.

### BACKGROUND

Current medical systems that provide a hospital or a hospital department an overview include a set of features that enables radiologists, technologists, and executives to obtain relevant information about scanners, scans, protocols, dose values, and other information. The medical systems require a user to find and use the correct features in the software to obtain the relevant information at a proper aggregation level. Navigating through the feature-based views costs the user time and thus money.

Many of the current medical systems present data to the user with feature-based views. The user actively searches for a feature to make use of the feature and accomplish a given task. Further, data representation across different features is not uniform. For example, patient image studies are presented to a physician in the form of lists sorted by creation date, patient name, or another parameter; radiation dose data is presented to the physician in the form of graphs; scanner protocols are presented in the form of trees; image sharing data is presented in the form of sharing lists tagged by topic. When these features are combined within a single system, the non-uniform presentation of the data again costs the user time and money.

### SUMMARY

In order to present medical information to a user in an easily consumed manner, a method and a system for identifying data to be displayed to a user are provided. Connections between users and devices are stored by a memory. The users are associated with first properties, and the devices are associated with second properties. A processor in communication with the memory identifies a first connection and a second connection from the stored connections based on the user. The data to be displayed to the user is identified based on the identified first connection, the identified second connection, or the identified first connection and the identified second connection.

In a first aspect, a method of identifying data to be displayed to a first user is provided. The method includes storing, by a database, connections between users and devices. The users include the first user and are associated with first properties. The devices are associated with second properties. The method also includes identifying, by a processor in communication with the database, a first connection and a second connection from the stored connections based on the first user. The first connection is between the first user and a second of the users. The second connection is between the first user and a first of the devices. The first connection indicates one of the first properties for the first user matches the one first property for the second user. The second connection indicates the one first property or another of the first properties for the first user matches one of the second properties for the first device. The method includes identifying the data to be displayed to the first user based on the identified first connection and the identified second connection.

In a second aspect, a method of displaying data to a first user is provided. The first user is associated with first properties. The method includes receiving, by an interface associated with the first user, one or more first datasets related to one or more second users, one or more second datasets related to one or more devices associated with second properties, or the one or more first datasets and the one or more second datasets. The one or more first datasets are data related to first properties of the one or more second users that match a first subset of the first properties for the first user, respectively. The one or more second datasets are data related to second properties of the one or more devices that match a second subset of the first properties for the first user, respectively. The method also includes displaying, by a display in communication with the interface, a subset of the one or more first datasets, the one or more second datasets, or the one or more first datasets and the one or more second datasets in an order. The method includes sorting, by a processor in communication with the display, the order based on the previous interactions by the first user, via an input device in communication with the display, with data displayed by the display.

In a third aspect, an apparatus for identifying data to be displayed to a user is provided. The apparatus includes a memory configured to store connections between users and devices. The users include the first user and are associated with first properties. The devices are associated with second properties. The apparatus also includes a processor in communication with the memory. The processor is configured to identify a first connection and a second connection from the stored connections based on the first user. The first connection is between the first user and a second of the users. The second connection is between the first user and a first of the devices. The first connection indicates one of the first properties for the first user matches the one first property for the second user. The second connection indicates the one first property or another of the first properties for the first user matches one of the second properties for the first device. The processor is also configured to identify the data to be displayed to the first user based on the identified first connection and the identified second connection.

In a fourth aspect, an apparatus for displaying data to a first user is provided. The first user is associated with first properties. The apparatus includes an interface associated with the first user. The interface is configured to receive one or more first datasets related to one or more second users, one or more second datasets related to one or more devices associated with second properties, or the one or more first datasets and the one or more second datasets. The one or more first datasets are data related to first properties of the one or more second users that match a first subset of the first properties for the first user, respectively. The one or more second datasets are data related to second properties of the one or more devices that match a second subset of the first properties for the first user, respectively. The apparatus also includes a display in communication with the interface. The display is configured to display a subset of the one or more first datasets, the one or more second datasets, or the one or more first datasets and the one or more second datasets in an order. The apparatus includes a processor in communication with the display. The processor is configured to sort the order based on previous interaction by the first user, via an input device in communication with the display, with data displayed by the display.

### BRIEF DESCRIPTION OF THE DRAWINGS

FIG. 1 shows a flowchart of one embodiment of a method for displaying data to a user;

FIG. 2 shows an example of a graphical representation of a user;

FIG. 3 shows exemplary datasets including graphical representations;

FIG. 4 shows exemplary connections between scanners and medical professionals;

FIG. 5 shows an exemplary connection between a scanner and a medical professional based on the department property;

FIG. 6 shows another exemplary connection between a scanner and a medical professional based on the department property;

FIG. 7 shows an exemplary connection between scanners and medical professionals based on the study property;

FIG. 8 shows an exemplary connection between scanners based on the modality type property;

FIG. 9 illustrates exemplary connection rules for first properties and second properties;

FIG. 10 shows examples of data to be displayed;

FIG. 11 shows an example of displayed data identified based on first connections and second connections;

FIG. 12 shows one example of a data protection model for a feed;

FIG. 13 shows one embodiment of a system for obtaining a personalized medical feed;

FIG. 14 shows one embodiment of components of a system for obtaining a personalized medical feed; and

FIG. 15 shows one embodiment of a general computer system.

### DETAILED DESCRIPTION OF THE DRAWINGS

Data to be displayed is divided into two parts: data about scanners; and data about medical professionals. The data about scanners is represented in a first graph, and data about the medical professionals is represented in a second graph. Each graph item of the first graph and the second graph has defined properties and may have connections to other graph items within the first graph and/or the second graph. The graph items to which a user is connected is displayed to the user as a continuous feed of micro-data items on every login to a medical system. The micro-data items are sorted inside the continuous feed according to previous user interactions with the continuous feed, taking into account first, second, and third degree connections. Statistically most interacted with micro-data item types are considered most relevant and are shown on top of the continuous feed.

The data to be displayed, related to, for example, patient image studies, radiation dose, scanner utilization, scanner protocols, and image sharing, is presented in a way that takes into account previous interactions with the data. The data is displayed in an order of significance according to the previous interactions with the data. This increases the ease with which the user may consume a large amount of data, reduces the time needed to consume a large amount of data on a daily basis, and represents the data in a way that is optimized to previous interactions in approximately real time.

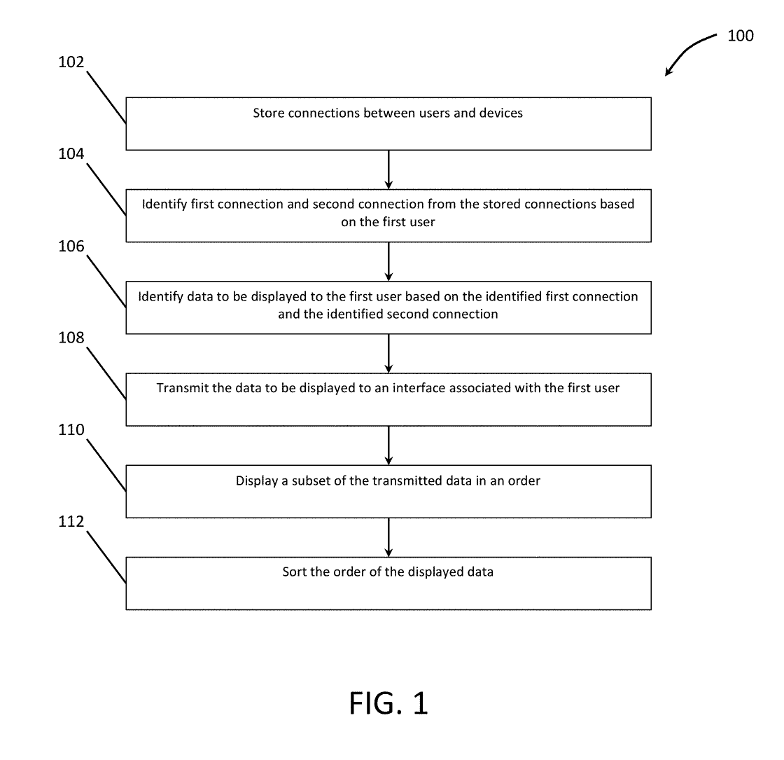

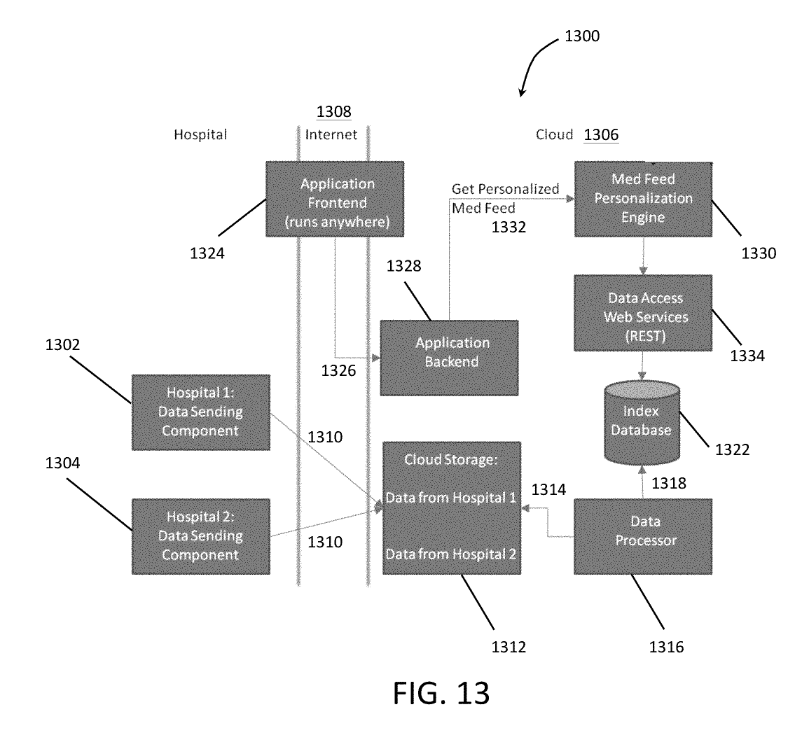

FIG. 1 shows a flowchart of one embodiment of a method 100 for displaying data to a first user. The method may be performed using the medical system shown in FIGS. 13-15 or another medical system. For example, the acts of the method are implemented by one or more processors using instructions from one or more memories. The method is implemented in the order shown, but other orders may be used. Additional, different, or fewer acts may be provided. Similar methods may be used for preloading image data.

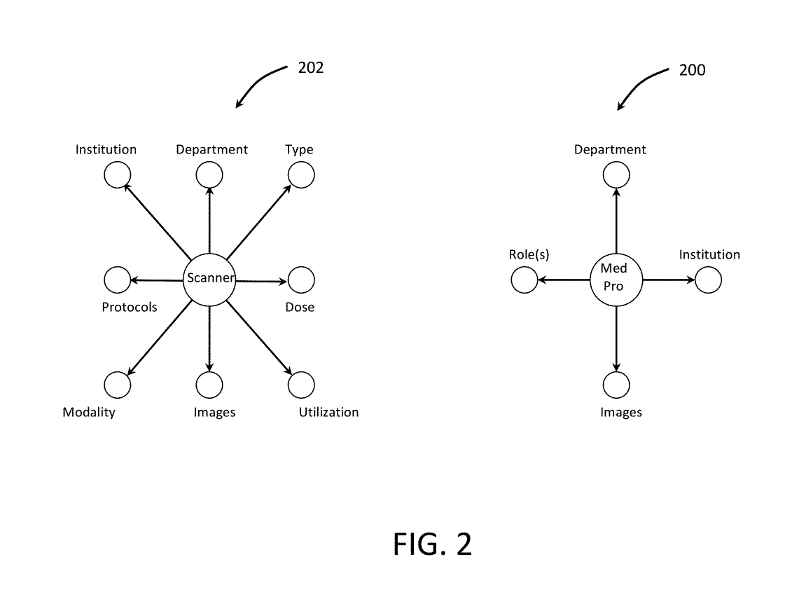

In act 102, a memory (e.g., including a database) stores connections between users (e.g., including the first user) and devices. FIG. 2 shows a graphical representation 200 (e.g., a “Med Professional Graph Entity”) of one of the users (e.g., “Med Professional”). The users are associated with first properties. In one embodiment, the first properties include an institution, a department, one or more roles, and images. In other embodiments, the first properties may include additional, fewer, and/or different properties.

The first property “Institution” represents hospitals with which the medical professional is affiliated. The first property “Department” represents hospital departments with which the medical professional is affiliated. The first property “Role” represents the role of the medical professional within the institution and/or the department. For example, the role for the medical professional may be radiologist, technologist, executive, administrator, and/or another role. The first property “Images” represents a list of studies acquired by the medical professional, a list of studies assigned to the medical professional for reading, a list of studies assigned to the medical professional for reporting, a list of studies shared with the medical professional, a list of studies shared by the medical professional, and/or other studies.

The devices may be medical imaging devices (e.g., scanners). In other embodiments, the devices may represent different devices. The devices are associated with second properties. FIG. 2 also shows a graphical representation 202 (e.g., a “Scanner Graph Entity”) of one of the scanners (e.g., “Scanner”). In one embodiment, the second properties include an institution, a department, a type of medical imaging device, protocols installed at the medical imaging device, dose values, a modality type, images, and utilization of the medical imaging device. In other embodiments, the second properties may include additional, fewer, and/or different properties.

The second property “Institution” represents institutions where the scanner is installed. The second property “Department” represents a department where the scanner is installed. The second property “Type of Scanner” represents the type of the scanner in terms of manufacturer and/or model. The second property “Protocols” represents protocols installed at the scanner. This includes, for example, in-depth information on protocols used and protocol change history. The second property “Dose Values” represents in-depth information on average dose exposed per scan type. The scan type is, for example, an intersection of four parameters: patient age group (e.g., 0-5, 5-10, 10-15, 15-20, 20-30, 30-40, 40-50, 50-60, 60-70, 70-80, 80-90, 90-100, 100-110, 110-120); patient weight group (e.g., 2-4, 4-6, 6-10, 10-15, 15-20, 20-30, 30-40, 40-50, 50-60, 60-70, 70-80, 80-90, 90-100, etc.); modality type (e.g., MRI, US, CT, X-Ray, PET/CT, DXA); and body region according to Digital Imaging and Communications in Medicine (DICOM). The second property “Modality” represents a modality type for the scanner. For example, the modality type for the scanner may be MRI, US, CT, X-Ray, PET/CT, DXA, or another modality type. The second property “Images” represents images acquired by the scanner. For example, this may represent a list of studies and series that were acquired at the scanner with image references. The second property “Utilization” represents the utilization of the scanner. This may include a list of scanner idle times, scan begin times, and/or scan end times over a lifetime of the scanner.

The memory stores datasets corresponding to each of the users and each of the scanners. The datasets include the graphical representations shown, for example, in FIG. 2 for each of the users and each of the scanners, and data for the corresponding first properties and second properties, respectively. The users and the scanners represented by the datasets may be users that work within and scanners that are installed at, respectively, hospitals, for example, that run software executing methods of the present embodiments.

A dataset for a user (e.g., first user) may be generated when the user starts working at an institution and/or a specific department. The dataset for the user is updated as data within the dataset for the user changes. For example, the dataset for the user may change when the user changes institutions, changes departments, changes roles, and/or is associated with more studies.

A dataset for a scanner may be generated when the scanner is installed at an institution and/or a particular department. The dataset for the scanner is updated as data within the dataset for the scanner changes. For example, the dataset for the scanner may change when the scanner is installed in a new institution, is installed in a new department, changes protocols, as doses are applied to respective patients, as images are acquired, and/or as scans are started and stopped.

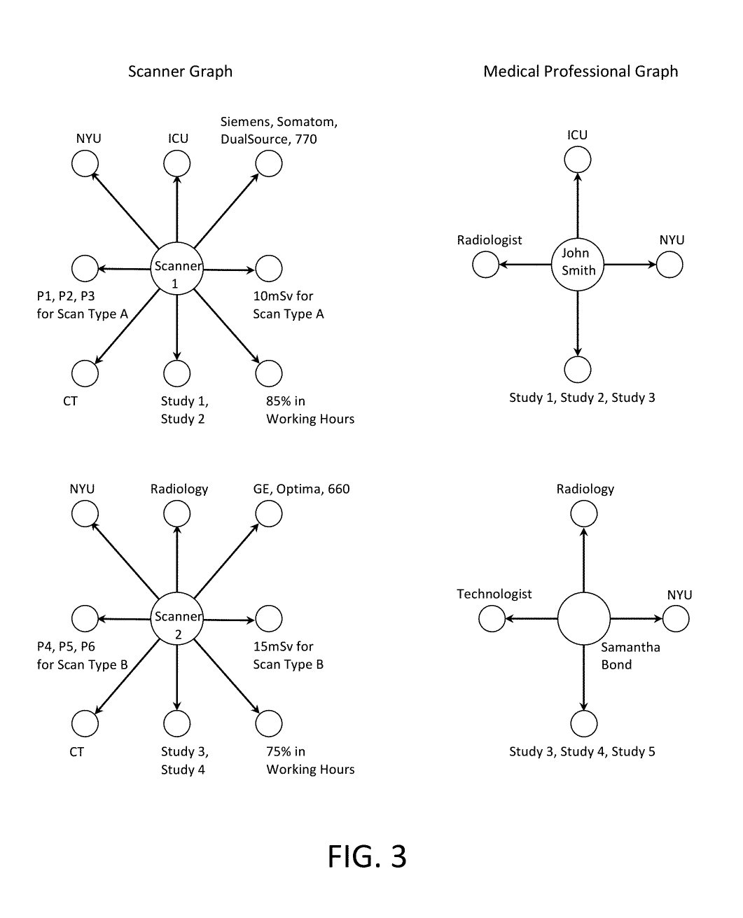

FIG. 3 shows exemplary datasets including graphical representations stored in the memory. As shown in FIG. 3, “Scanner 1” is installed at New York University (NYU) in the intensive care unit (ICU). Further, Scanner 1 is a Siemens, Somatom, Dual Source 770 type scanner. Scanner 1 has protocols P1, P2, and P3 installed, which are used for Scan Type A. Dose values applied are 10 mSv for Scan Type A, and the modality is CT. Images acquired by Scanner 1 include Study 1 and Study 2, and the utilization of Scanner 1 is on average 85% in working hours. “Scanner 2” is also installed at NYU, but in the radiology department. Scanner 2 is a GE, Optima 660 type of scanner. Protocols P4, P5, and P6, which are used for Scan Type B, are installed on Scanner 2. Dose values applied are 15 mSv for Scan Type B, and the modality is CT. Images acquired by Scanner 2 include Study 3 and Study 4, and the utilization of Scanner 2 is on average 75% in working hours.

The user (e.g., medical professional) “John Smith” (e.g., the first user) is from the institution NYU in the ICU department. The role for John Smith is radiologist, and Study 1, Study 2, and Study 3 are associated with John Smith. The user (e.g., medical professional) “Samantha Bond” (e.g., a second user) is from the institution NYU in the radiology department. The role for Samantha Bond is technologist, and Study 3, Study 4, and Study 5 are associated with Samantha Bond.

A processor in communication with the memory (e.g., a first processor) identifies the connections between the users and the devices based on the datasets (e.g., the graphical representations) corresponding to the users and the scanners, respectively. For example, the first processor identifies the connections between the users and the devices by identifying property matches between the users and the devices. Identifying the property matches between the users and the devices includes comparing, for each of the users, the first properties for the user to the first properties for the other users. Identifying the property matches also includes comparing, for each of the devices, the second properties for the device to the second properties for the other devices, and comparing, for each of the users, the first properties for the user to the second properties for the devices.

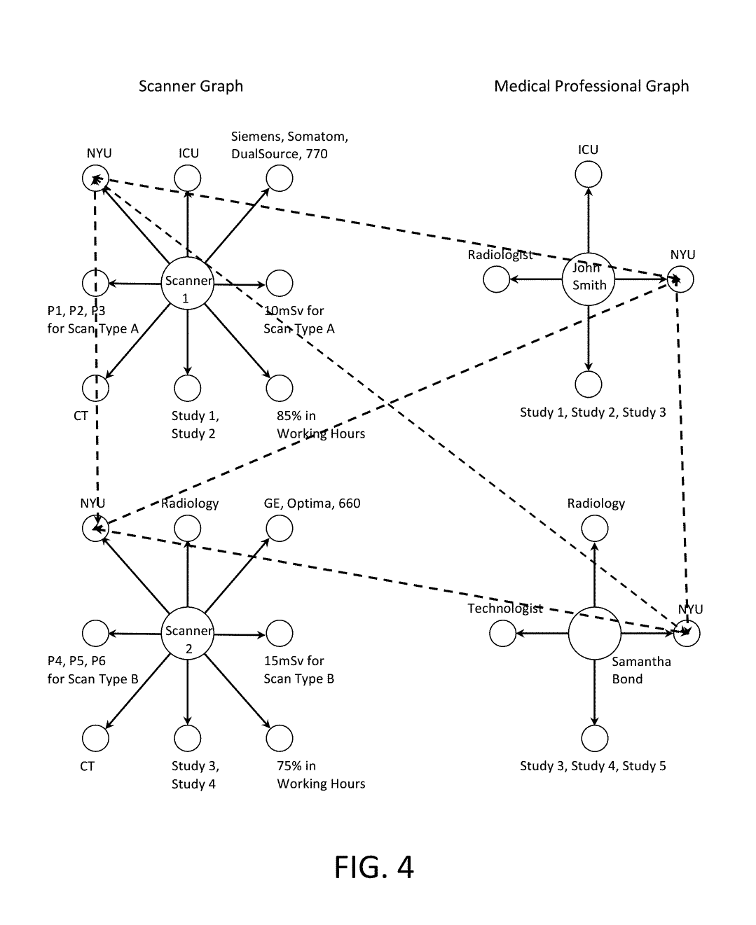

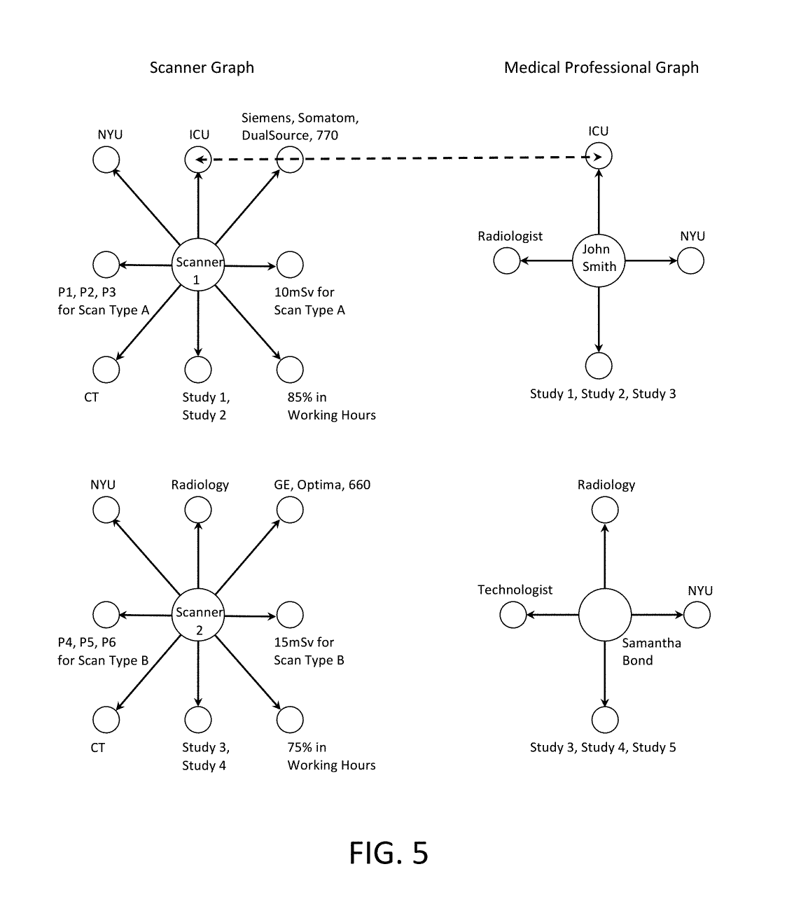

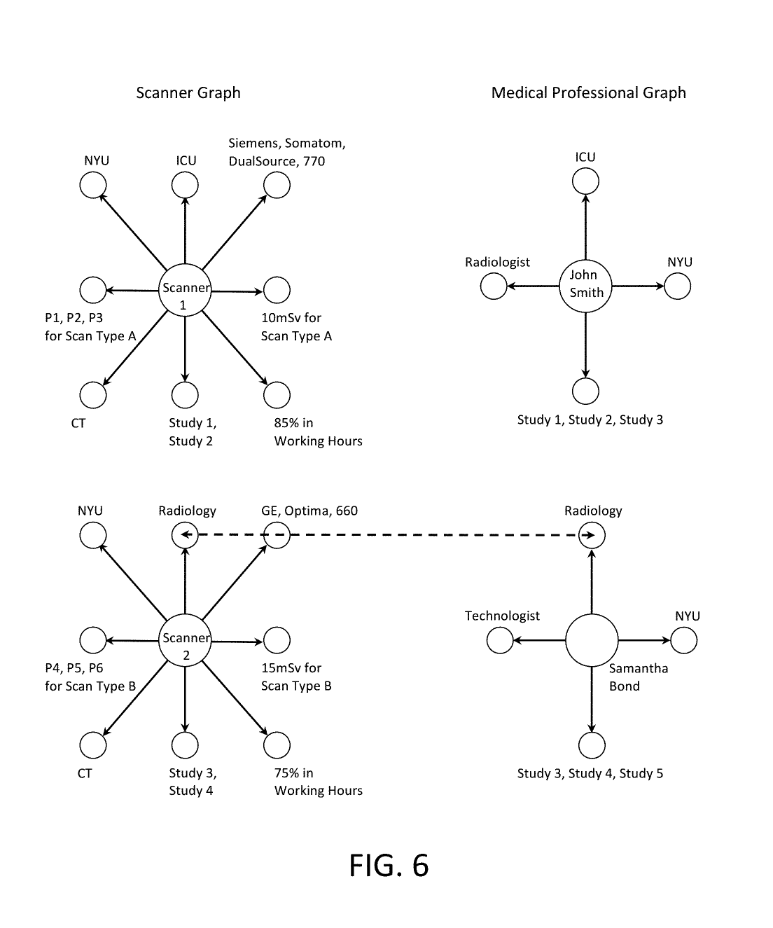

FIG. 4 shows identified connections between Scanner 1, Scanner 2, John Smith, and Samantha Bond based on the institution property. Scanner 1, Scanner 2, John Smith, and Samantha Bond all have the institution property of NYU. FIG. 5 shows an identified connection between Scanner 1 and John Smith based on the department property. Scanner 1 and John Smith both have the department property of ICU. In other words, Scanner 1 and John Smith belong to the same hospital department, ICU, of the same hospital. FIG. 6 shows an identified connection between Scanner 2 and Samantha Bond based on the department property. Scanner 2 and Samantha Bond both have the department property of radiology. In other words, Scanner 2 and Samantha Bond belong to the same hospital department, radiology, of the same hospital.

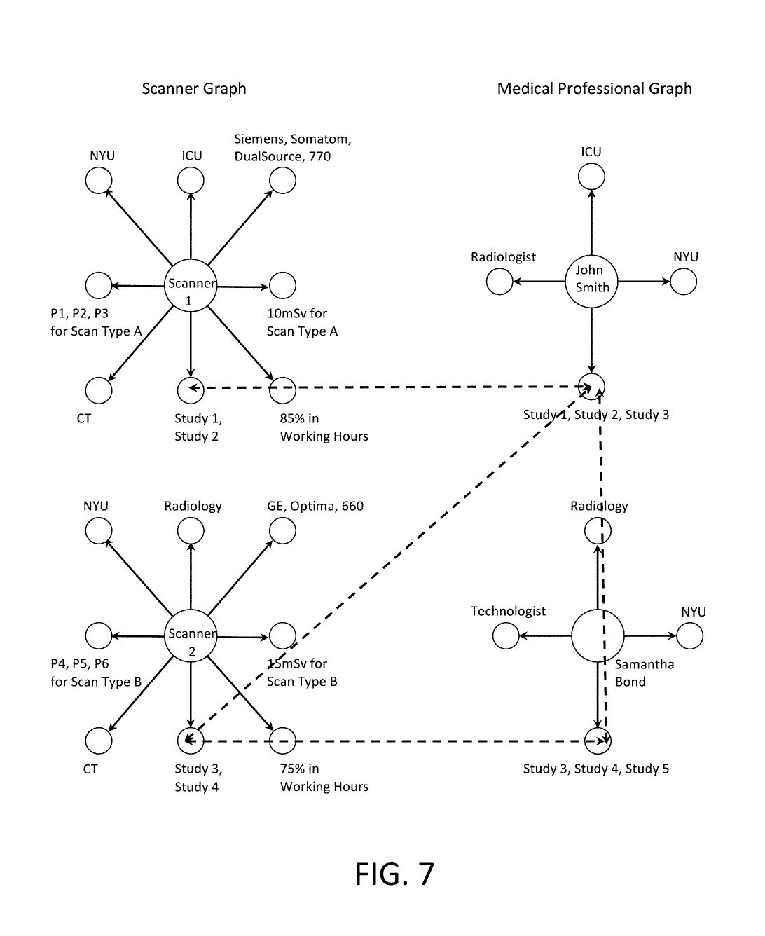

FIG. 7 shows identified connections between Scanner 1, Scanner 2, John Smith, and Samantha Bond based on the study property. Study 1 was acquired by Scanner 1, and John Smith was assigned to read Study 1. Accordingly, Scanner 1 and John Smith are connected based on the study property. Study 3 was acquired by Scanner 2, and Samantha Bond was assigned to read Study 3. Accordingly, Scanner 2 and Samantha Bond are connected based on the study property. Samantha Bond shared Study 3 with John Smith to get his opinion on the study. Accordingly, Samantha Bond and John Smith are connected based on the study property. Since Study 3 was acquired by Scanner 2 and has been shared with John Smith, Scanner 2 and John Smith are connected based on the study property.

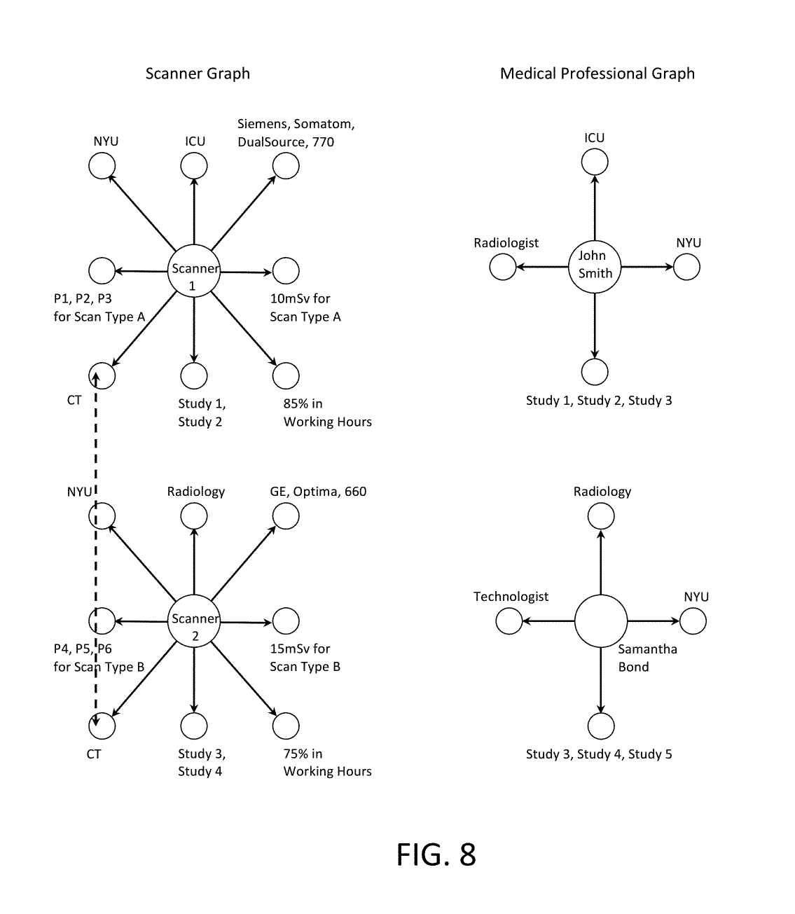

FIG. 8 shows an identified connection between Scanner 1 and Scanner 2 based on the modality type property. Scanner 1 and Scanner 2 are both CT devices. Accordingly, Scanner 1 and Scanner 2 are connected based on the modality property.

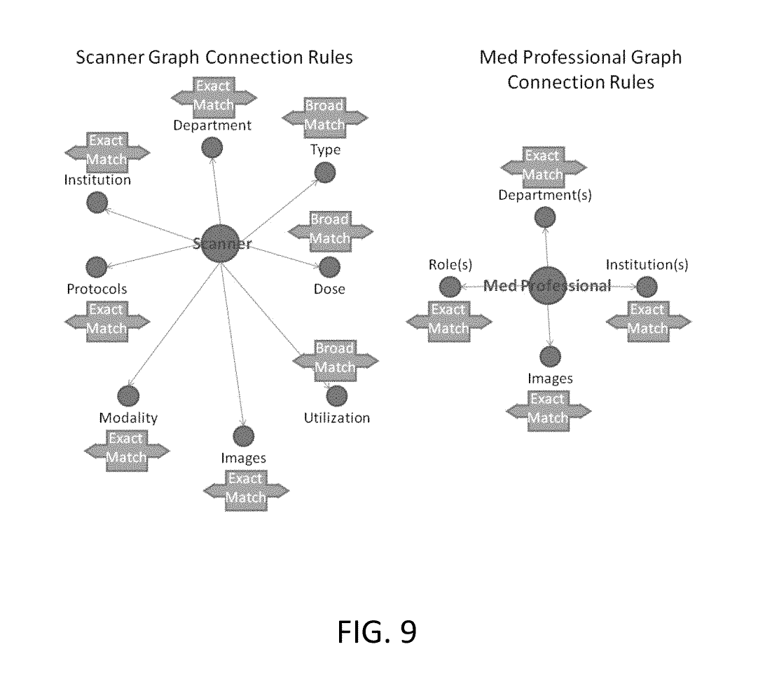

In one embodiment, each property of the first properties and the second properties has a rule based on which a connection may be established. FIG. 9 illustrates exemplary connection rules for the first properties and the second properties. First properties that use exact matches for connections include: institution names; department names; role names; and imaging study IDs. Second properties that use exact matches for connections include: institution names; department names; protocol names; modality type names; and imaging study IDs. Second properties that use broad matches include: scanner types; utilization; and dose. For example, with scanner types, the manufacturer and the model may be matched exactly, whereas hardware versions and software versions may be matched broadly or may not match at all. For utilization, a connection may be identified within a first predetermined percentage (e.g., 20%). In other words, a utilization connection may be identified when the average utilization for one scanner (e.g., Scanner 1) is within 20%, for example, of the average utilization for another scanner (e.g., Scanner 2). For dose, a connection may be identified within a second predetermined percentage (e.g., 10%). In other words, a dose connection may be identified when the average dose for one scanner (e.g., Scanner 1) is within 10%, for example, of the average dose for another scanner (e.g., Scanner 2). For example, based on the first predetermined percentage and the second predetermined percentage, the first processor determines, for each of the devices, a first subset of the devices for which dose values are within a first percentage of dose values of the device and/or determines a second subset of the devices for which utilization of the device is within a second percentage of utilization of the device. In other embodiments, other matching criteria may be used. For example, in one embodiment, all matches have to be exact matches for a connection to be identified.

In act 104, the first processor or another processor identifies a first connection and a second connection from the stored connections based on the first user (e.g., John Smith). First connections may be between users, and second connections may be between a user and a scanner. The first connection and the second connection may be direct connections from the first user.

The first processor may identify the first connection and the second connection, for example, by identifying and analyzing the dataset (e.g., the graphical representation) for the first user, John Smith, within the memory. In other examples, the first processor may identify a number of first connections and second connections to the first user from the stored connections.

As an example, the first connection is between the first user and, for example, the second user (e.g., Samantha Bond). The first connection indicates one of the first properties for the first user (e.g., institution) matches the one first property for the second user (e.g., institution). For example, as shown in FIGS. 3-8, the first user, John Smith, is from the same institution, NYU, as the second user, Samantha Bond. FIGS. 3-8 also illustrate an additional first connection with Samantha Bond, Study 3.

As an example, the second connection is between the first user and a first of the devices (e.g., Scanner 1). The second connection indicates the one first property (e.g., institution) or another of the first properties (e.g., images) for the first user matches one of the second properties (e.g., institution, images) for the first device. For example, as shown in FIGS. 3-8, the first user, John Smith, is from the same institution in which Scanner 1 is installed, NYU. FIGS. 3-8 also illustrate additional second connections, Study 1 and Study 2.

In one embodiment, the first processor may identify different degree connections (e.g., first connections and/or second connections) for the first user. For example, for the first user, the first processor may identify first degree connections, second degree connections, and third degree connections. In another embodiment, the first processor identifies higher degree connections. In yet another embodiment, the first processor identifies only first degree connections and second degree connections.

First degree connections are connections that the user (e.g., the first user) has directly with, for example, medical professionals (e.g., first connections) and scanners (e.g., second connections). Second degree connections are connections that the scanners and the medical professionals from the first degree connections have with other scanners and medical professionals. Third degree connections are connections that the scanners and the medical professionals from the second degree connections have with other scanners and medical professionals. In one embodiment, when the first processor identifies the connections, the first processor only considers the connection once. For example, John Smith to Scanner 1 is only considered the first time the connection occurs. Subsequent occurrences of the connection may be ignored when the first processor identifies connections (e.g., graph traversing).

In act 106, the first processor or another processor identifies the data to be displayed (e.g., micro-data items) to the first user based on the identified first connection and the identified second connection. The identified data to be displayed includes one or more first datasets related to one or more second users. The one or more first datasets include data related to first properties of the one or more second users that match a first subset of the first properties (e.g., some or all of the first properties) for the first user, respectively. Using the example discussed above with respect to act 104, the first user, John Smith, and the second user, Samantha Bond, have a first connection of Study 3. The identified data to be displayed includes data related to Samantha Bond's activities related to Study 3. In other words, with respect to the second user, the identified data to be displayed to the first user includes only data related to the first connections. In one embodiment, once a first connection is identified between the first user and another user (e.g., the second user), the identified data to be displayed includes all data related to all properties for the other user.

The identified data to be displayed includes one or more second datasets related to one or more devices. The one or more second datasets include data related to second properties of the one or more devices that match a second subset of the first properties (e.g., some or all of the first properties) for the first user, respectively. Using the example discussed above with respect to act 104, the first user, John Smith, and the first device, Scanner 1, have second connections of Study 1 and Study 2. The identified data to be displayed includes data related to activities of Scanner 1 related to Study 1 and Study 2. In other words, with respect to Scanner 1, the identified data to be displayed to the first user includes only data related to the second connections. In one embodiment, once a second connection is identified between the first user and one of the devices (e.g., the first device), the identified data to be displayed includes all data related to all properties for the one device.

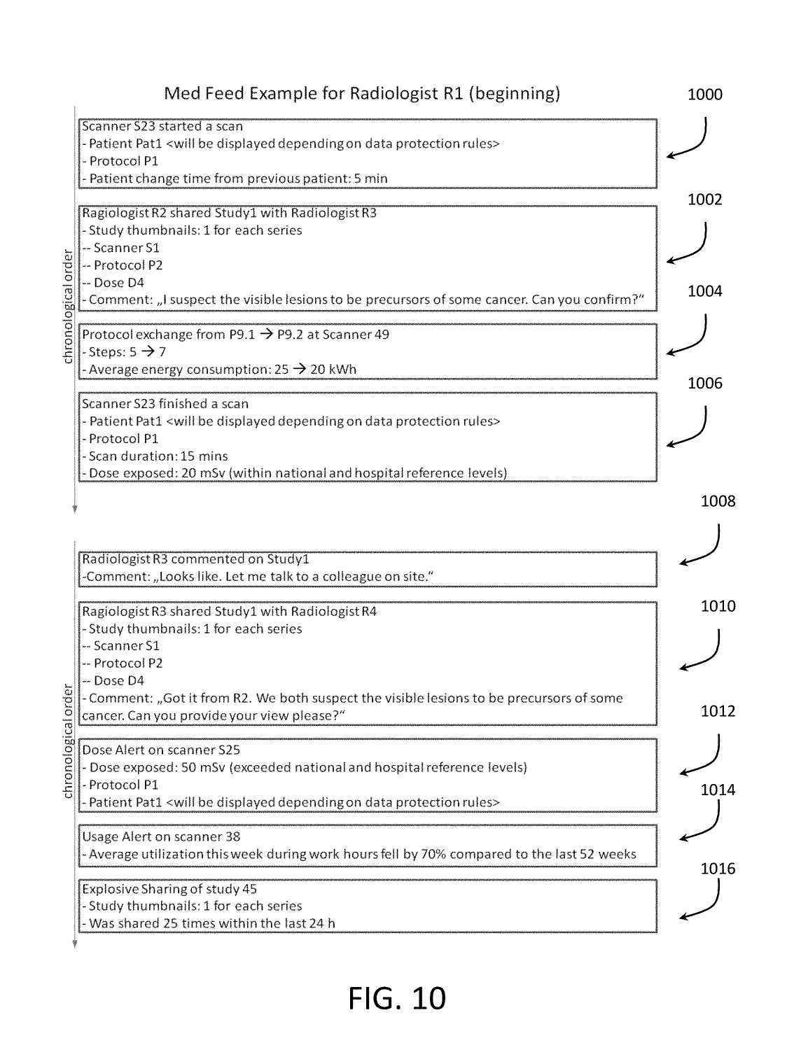

FIG. 10 shows examples of data to be displayed (e.g., micro-data item types) that may be identified based on the first connections and second connections identified in act 104. The first micro-data item type 1000 is “scan started,” which includes, for example, data related to which patient is scanned depending on data protection rules (see description below), which protocol is used, and how long it took to change a patient at the scanner used before the scan began. The first micro-data item type 1000 may include more, less, and/or different information about the scan and/or other information. For example, the first micro-data item type 1000 may include data related to a time at which the scan started.

The second micro-data item type 1002 is “study sharing performed,” which includes, for example, a small image (e.g., a thumbnail) for each series of the study, data related to the scanner where the study was acquired, data related to the protocol used to acquire the study, data related to the radiation dose exposed, and a comment for a receiving user (e.g., a radiologist). The second micro-data item type 1002 may include more, less, and/or different information about the study shared and/or other information.

The third micro-data item type 1004 is “protocol exchange performed,” which includes, for example, data related to changes in the protocol. The changes in the protocol may identify what has changed between an old protocol and a new protocol. For example, the changes in the protocol may identify an increase or a decrease in a number of steps to acquire a study and/or a change (e.g., an increase or a decrease) in an average energy consumption of the scanner during a scan. The third micro-data item type 1004 may include more, less, and/or different information about the protocol and/or other information.

The fourth micro-data item type 1006 is “scan finished,” which includes, for example, data related to which patient was scanned depending on the data protection rules, which protocol was used, and how long the scanner took to perform the scan. The fourth micro-data item type 1006 may also include data related to how much radiation dose was exposed and whether the exposed radiation is within national and/or hospital-set dose reference values. The fourth micro-data item type 1006 may include more, less, and/or different information about the scan and/or other information. For example, the fourth micro-data item type 1006 may include data related to a time at which the scan ended.

The fifth micro-data item type 1008 is “comment,” which includes, for example, comments on a shared study. The fifth micro-data item type 1008 may include more, less, and/or different information about the shared study.

The sixth micro-data item type 1010 is “study sharing performed,” which includes, for example, an image (e.g., thumbnail) for each series of the study, data related to where the study was acquired, data related to the protocol used to acquire the study, data related to the radiation dose exposed, and one or more comments for the receiving user (e.g., a radiologist). The sixth micro-data item type 1010 may include more, less, and/or different information about the shared study.

The seventh micro-data item type 1012 is “dose alert,” which includes, for example, a warning when a scan exceeds national and/or hospital-set dose reference values. The seventh micro-data item type 1012 may also include data related to the protocol used during the scan and data related to which patient was scanned depending on the data protection rules. The seventh micro-data item type 1012 may include more, less, and/or different information about the shared study.

The eighth micro-data item type 1014 is “utilization alert,” which includes, for example, data related to utilization of the scanner. For example, the data related to the utilization of the scanner may include an increase or a decrease (e.g., percent increase or decrease) over a time period (e.g., a week) compared to a previous time period (e.g., the previous year). The eighth micro-data item type 1014 may include more, less, and/or different information about the utilization.

The ninth micro-data item type 1016 is “high sharing,” which includes data related to a number of times a particular study is shared. For example, the ninth micro-data item type 1016 includes data related to studies that are shared above a threshold number of times over a predetermined time period (e.g., 24 hours). The data related to the studies may include data related to where the number of shares over the 24 hour period, for example, ranks compared to other shared studies. The ninth micro-data item type 1016 may include more, less, and/or different information about the study.

In one embodiment, at least some of the micro-data item types 1000-1016, for example, include clickable hyperlinks. For example, the underlined text in FIG. 10 may represent clickable hyperlinks. A user (e.g., the first user) may select (e.g., click), with an input device (e.g., a mouse), a clickable hyperlink to open a more detailed view.

The identified data to be displayed may include data related to micro-data item types 1000-1016 discussed above. More, fewer, and/or different micro-data items types may be defined and included within the data to be displayed. The memory or another memory may store the data related to the micro-data item types. For example, scanners and workstations may identify the data related to the micro-data item types (e.g., when a scan is started) during operation and transmit the data to the memory or the other memory for storage.

The identified data to be displayed may include data related to micro-data item types 1000-1016, for example, for a number of different degree connections to the first user. For example, the identified data to be displayed may include data related to micro-data item types 1000-1016 for all first degree connections, second degree connections, and third degree connections.

In act 108, the data to be displayed is transmitted to an interface associated with the first user. For example, the data to be displayed is transmitted to a computing device (e.g., a workstation) including the interface. The first user may view the transmitted data via the computing device. In one embodiment, the computing device is a workstation, and the first user is a medical professional such as, for example, a doctor or a nurse. The interface of the computing device receives the transmitted data (e.g., including the one or more first datasets, the one or more second datasets, or the combination thereof).

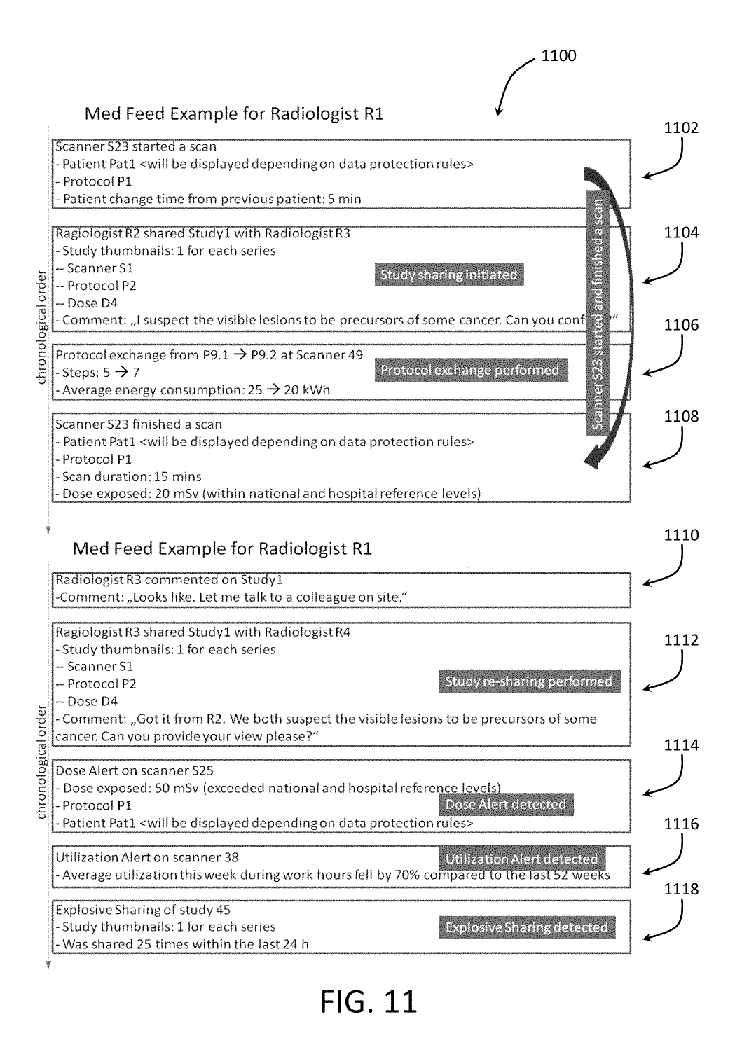

In act 110, a display (e.g., a monitor) displays a subset of the transmitted data in an order (e.g., a feed). FIG. 11 shows an example of displayed data identified based on the first connections and second connections identified in act 104. At the top of the feed 1100, a micro-data item 1102 about a scan beginning at Scanner 23 is displayed. The micro-data item 1102 shows which patient is scanned, depending on data protection rules, which protocol is used, and how long it took to change the patient at the scanner before the scan began.

Below the micro-data item 1102, micro-data item 1104 about a study sharing initiated by Radiologist 23 is displayed. The micro-data item 1104 shows a thumbnail for each series of the study, the scanner where the study was acquired, the protocol used to acquire the study, the radiation dose exposed, and a comment for the receiving Radiologist R3.

Below the micro-data item 1104, micro-data item 1106 about a protocol exchange event at Scanner 49 is displayed. The micro-data item 1106 shows what the new protocol does (e.g., protocol 9. 2 increases the number of steps needed to acquire a study from 5 (current) to 7 (new) and reduces an average energy consumption of the scanner during the scan by 5 kWh).

Below the micro-data item 1106, micro-data item 1108 about the scan at Scanner 23 from micro-data item 1102 ending is displayed. The micro-data item 1108 shows which protocol was used, how long it took to perform the scan, how much radiation dose was exposed, and a note comparing the exposed radiation with the national and hospital-set dose reference values. For example, the micro-data item 1108 may include a warning when the exposed radiation is greater than the national reference dose value and/or the hospital-set dose reference value.

Below the micro-data item 1108, micro-data item 1110 about a comment by Radiologist R3 on shared Study 1 is displayed. Micro-data item 1110 may include additional information, such as a history of other comments made by Radiologist R3 on shared Study 1.

Below micro-data item 1110, micro-data item 1112 about a re-sharing of Study 1 by Radiologist R3 is displayed. Micro-data item 1112 shows a thumbnail for each series of the study, the scanner where the study was acquired, the protocol used to acquire the study, the radiation dose exposed, and a comment for receiving Radiologist R4.

Below micro-data item 1112, micro-data item 1114 about a dose alert at Scanner 25 is displayed. The micro-data item 1114 shows (e.g., warns) that a scan exceeded both national and hospital-set dose references values. In one embodiment, the micro-data item 1114 warns that the scan exceeded the national dose reference value and/or the hospital-set dose reference value. The micro-data item 1114 also shows the protocol used during the scan and which patient was scanned, depending on the data protection rules.

Below micro-data item 1114, micro-data item 1116 about a utilization alert for Scanner 38 is displayed. The micro-data item 1116 shows, for example, how utilization for a scanner over a first time period compares to utilization for the scanner over a second time period (e.g., utilization fell 70% this week compared to the previous 52 weeks).

Below micro-data item 1116, micro-data item 1118 about Study 45 being shared by a number of users (e.g., explosively) is displayed. The micro-data item 1118 shows, for example, Study 45 was shared 25 times within the last 24 hours and that a study being shared 25 times within the last 24 hours is an all time high.

The subset of the transmitted data to be displayed may include all or less than all of the transmitted data. For example, the display may display less than all of the transmitted data based on locations of the first user and an origin of the transmitted data, respectively. A second processor (e.g., a processor of the computing device) identifies a location of the first user and identifies locations of origin of the one or more first datasets, the one or more second datasets, or the one or more first datasets and the one or more second datasets, respectively. The second processor compares the location of the first user to the locations of origin, respectively, and determines the subset of the transmitted data to be displayed.

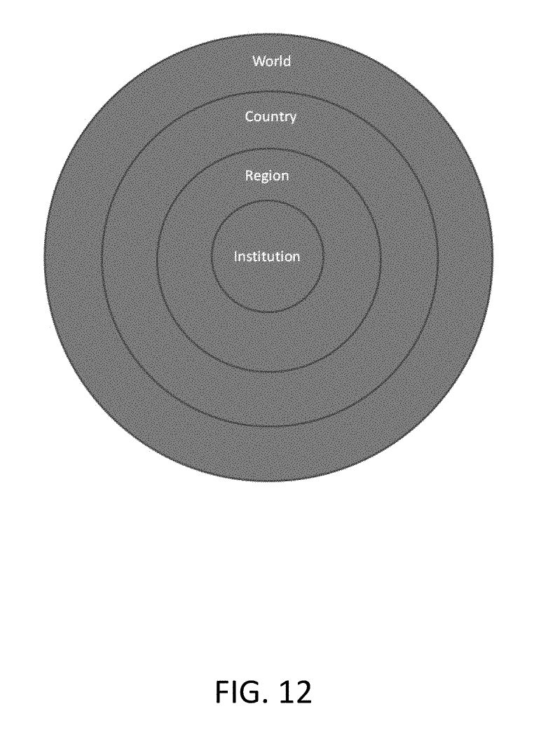

FIG. 12 shows one example of a data protection model for the feed. FIG. 12 illustrates a model with a medical institution embedded inside a geographical region. The geographical region is embedded inside a country. The country is embedded inside the world. The data protection model may include more, fewer, and/or different geographical entities.

The model shown in FIG. 12 is used for data protection for the feed. The second processor, for example, compares two different locations, a current geographical location of the user (e.g., the first user) and a geographical location of an origin of the micro-data item to be displayed (see FIGS. 10 and 11). Based on the result of the comparison, the second processor, for example, determines whether patient health information (PHI) data is to be displayed within the feed. For example, the PHI data may include a patient name or other information about the patient.

The second processor or another processor may compare the current geographical location of the first user with the geographical location of origin of the micro-data item to be displayed. The second processor or the other processor may determine the current geographical location of the first user based on data stored at, for example, the computing device of the first user. For example, the second processor may determine the current geographical location of the first user based on an IP address via which the computing device of the first user accesses a network. The second processor may determine the geographical location of the origin of the micro-data item to be displayed based on data included within the micro-data item. For example, the micro-data item may include data related to the geographical location of the origin of the micro-data item to be displayed. The second processor or the other processor may determine the current geographical location of the first user and the geographical location of the origin of the micro-data item, respectively, in any number of other ways.

Table 1 illustrates an example of the comparison of the two different locations.

TABLE 1

| | Geo Location of origin of micro-data item | | | |
|---|---|---|---|---|
| | | | Outside the | |
| | | Off premise and | region and in the | Outside the |
| | On premise of | in the region of | country of | country of |
| Current Geo | affiliated | affiliated | affiliated | affiliated |
| Location of user | institution A | institution A | institution A | institution A |
| On premise of | Full Trust: | High Trust: | Medium Trust: | Low Trust: |
| affiliated | show all PHI | do not show PHI | do not show PHI | do not show PHI |
| institution A | details of all | details for | details for | details for |
| | micro-data items | countries on | countries on | countries on |
| | | Exclusion List 1 | Exclusion List 2 | Exclusion List 3 |
| Off premise and | High Trust: | High Trust: | Medium Trust: | Low Trust: |
| in the region of | do not show PHI | do not show PHI | do not show PHI | do not show PHI |
| affiliated | details for | details for | details for | details for |
| institution A | countries on | countries on | countries on | countries on |
| | Exclusion List 1 | Exclusion List 1 | Exclusion List 2 | Exclusion List 3 |
| Outside the | High Trust: | Medium Trust: | Medium Trust: | Low Trust: |
| region and in the | do not show PHI | do not show PHI | do not show PHI | do not show PHI |
| country of | details for | details for | details for | details for |
| affiliated | countries on | countries on | countries on | countries on |
| institution A | Exclusion List 1 | Exclusion List 2 | Exclusion List 2 | Exclusion List 3 |
| Outside the | Medium Trust: | Medium Trust: | Medium Trust: | Low Trust: |
| country of | do not show PHI | do not show PHI | do not show PHI | do not show PHI |
| affiliated | details for | details for | details for | details for |
| institution A | countries on | countries on | countries on | countries on |
| | Exclusion List 2 | Exclusion List 2 | Exclusion List 2 | Exclusion List 3 |

With reference to Table 1, if the current geographical location of the user (e.g., the first user) is on premise of an affiliated institution A and the geographical location of the origin of the micro-data item to be displayed is on premise of the affiliated institution A, full trust is provided, and all PHI details of the micro-data item are displayed. If the current geographical location of the first user is on premise of the affiliated institution A and the geographical location of the origin of the micro-data item to be displayed is off premise but in the region of the affiliated institution A, high trust is provided, and PHI details are not shown for countries on Exclusion List 1. The region may be defined in any number of ways. For example, the region may be defined by a distance from the affiliated institution A (e.g., 50 miles), or a city or state. If the current geographical location of the first user is on premise of the affiliated institution A and the geographical location of the origin of the micro-data item to be displayed is outside of the region but in the country of the affiliated institution A, medium trust is provided, and PHI details are not shown for countries on Exclusion List 2. If the current geographical location of the first user is on premise of the affiliated institution A and the geographical location of the origin of the micro-data item to be displayed is outside the country of the affiliated institution A, low trust is provided, and PHI details are not shown for countries on Exclusion List 3.

If the current geographical location of the first user, for example, is off premise but in the region of the affiliated institution A and the geographical location of the origin of the micro-data item to be displayed is on premise of the affiliated institution A, high trust is provided, and PHI details are not shown for countries on Exclusion List 1. If the current geographical location of the first user is off premise but in the region of the affiliated institution A and the geographical location of the origin of the micro-data item to be displayed is off premise but in the region of the affiliated institution A, high trust is provided, and PHI details are not shown for countries on Exclusion List 1. If the current geographical location of the first user is off premise but in the region of the affiliated institution A and the geographical location of the origin of the micro-data item to be displayed is outside of the region but in the country of the affiliated institution A, medium trust is provided, and PHI details are not shown for countries on Exclusion List 2. If the current geographical location of the first user is off premise but in the region of the affiliated institution A and the geographical location of the origin of the micro-data item to be displayed is outside the country of the affiliated institution A, low trust is provided, and PHI details are not shown for countries on Exclusion List 3.

If the current geographical location of the first user, for example, is outside of the region but in the country of the affiliated institution A and the geographical location of the origin of the micro-data item to be displayed is on premise of the affiliated institution A, high trust is provided, and PHI details are not shown for countries on Exclusion List 1. If the current geographical location of the first user is outside of the region but in the country of the affiliated institution A and the geographical location of the origin of the micro-data item to be displayed is off premise but in the region of the affiliated institution A, medium trust is provided, and PHI details are not shown for countries on Exclusion List 2. If the current geographical location of the first user is outside of the region but in the country of the affiliated institution A and the geographical location of the origin of the micro-data item to be displayed is outside of the region but in the country of the affiliated institution A, medium trust is provided, and PHI details are not shown for countries on Exclusion List 2. If the current geographical location of the first user is outside of the region but in the country of the affiliated institution A and the geographical location of the origin of the micro-data item to be displayed is outside the country of the affiliated institution A, low trust is provided, and PHI details are not shown for countries on Exclusion List 3.

If the current geographical location of the first user, for example, is outside of the country of the affiliated institution A and the geographical location of the origin of the micro-data item to be displayed is on premise of the affiliated institution A, medium trust is provided, and PHI details are not shown for countries on Exclusion List 2. If the current geographical location of the first user is outside of the country of the affiliated institution A and the geographical location of the origin of the micro-data item to be displayed is off premise but in the region of the affiliated institution A, medium trust is provided, and PHI details are not shown for countries on Exclusion List 2. If the current geographical location of the first user is outside of the country of the affiliated institution A and the geographical location of the origin of the micro-data item to be displayed is outside of the region but in the country of the affiliated institution A, medium trust is provided, and PHI details are not shown for countries on Exclusion List 2. If the current geographical location of the first user, for example, is outside of the country of the affiliated institution A and the geographical location of the origin of the micro-data item to be displayed is outside the country of the affiliated institution A, low trust is provided, and PHI details are not shown for countries on Exclusion List 3.

In other embodiments, different trust levels may be provided for different comparison results. For example, when the user (e.g., the first user) is outside the country of the affiliated institution A, the trust level may be low regardless of the geographic location of the origin of the micro-data item to be displayed.

Exclusion List 1 includes countries where the data is not to leave the institution. Exclusion List 2 includes countries where the data is not to leave the region of the institution. Exclusion List 3 includes countries where the data is not to leave the country of the institution. Exclusion List 1, Exclusion List 2, and Exclusion List 3 are stored in the memory or another memory (e.g., cloud storage) and may be updated continuously to reflect current medical data protection laws around the world.

In one embodiment, at least one dataset of the transmitted data that is displayed in act 110 includes one or more selectable hyperlinks. Each of the selectable hyperlinks links to additional data related to the corresponding dataset.

In act 112, the second processor, which is in communication with the display, sorts the order of the displayed data. The second processor sorts the displayed data based on previous interactions by the first user, via an input device in communication with the display, with the displayed data.

In one embodiment, the method further includes monitoring the input device associated with the display (e.g., the computing device of the first user) and storing data related to selection of the selectable hyperlink by the input device. The data may be stored within a memory of the computing device or another memory. For example, selections by the first user, for example, are tracked in order to build a history of items that are most interesting to the first user. The history for the first user, for example, may be used to construct a personalized feed for the first user (e.g., sort the order) based on interests identified by previous interactions (e.g., clicks to open more detailed views, longer periods of hovering or staying over a micro-data item type, use of a feature such as study sharing).

Table 2 illustrates a table of exemplary sorting rules based on previous interactions.

TABLE 2

| | | | Influence on sort within the |
|---|---|---|---|
| | | | Common Med Feed to obtain a |
| Rule # | Interaction | Example | Personalized Med Feed |
| 1 | Number of own clicks | Number of own clicks | Rank all micro-data item types by |
| | on a particular micro- | on Scanner within the | the cumulative number of clicks. |
| | data item type for the | micro-data item type | Push them into the Personalized |
| | past 3 months | “Scan started” | Feed in the descending order |
| 2 | Number of times a | Number of times | Take all micro-data items types |
| | feature has been used | sharing a study or | directly related to the object of |
| | by the current user for | exchanging a scan | the feature application (e.g. Study |
| | the past 3 months | protocol has been done | X, Protocol Y). Push them into the |
| | | by the current user | Personalized Feed in arbitrary |
| | | | order after Rule #1 items have |
| | | | been processed |
| 3 | Number of own | Number of own | Rank all micro-data items types by |
| | seconds hovering over | seconds hovering over | the cumulative number of |
| | a micro-data item | series thumbnails | seconds. Push into the |
| | type for the past 3 | within the micro-data | Personalized Feed in the |
| | months | item type “Study | descending order after Rule #2 |
| | | sharing performed” | items have been processed |
| 4 | Number of own | Number of own | Rank all micro-data items types by |
| | seconds staying on a | seconds staying on a | the cumulative number of |
| | micro-data item type | series thumbnail within | seconds. Push into the |
| | for the past 3 months | the micro-data item | Personalized Feed in the |
| | | type “Study sharing | descending order after Rule #3 |
| | | performed” | items have been processed |
| 5 | Number of clicks on a | Number of clicks on | Rank all micro-data item types by |
| | particular micro-data | Scanner within the | the cumulative number of clicks. |
| | item type for the past | micro-data item type | Push them into the Personalized |
| | 3 months by medical | “Scan started” by | Feed in the descending order after |
| | professionals of first, | medical professionals | Rule #4 items have been |
| | second or third degree | of first, second or third | processed |
| | connections | degree connections | |
| 6 | Number of times a | Number of times | Take all micro-data items types |
| | feature has been used | sharing a study or | directly related to the object of |
| | by the medical | exchanging a scan | the feature application (e.g. Study |
| | professionals of first, | protocol has been done | X, Protocol Y). Push them into the |
| | second or third degree | by the medical | Personalized Feed in arbitrary |
| | connection for the | professionals of first, | order after Rule #5 items have |
| | past 3 months | second or third degree | been processed |
| | | connection | |
| 7 | Number of seconds | Number of seconds | Rank all micro-data items types by |
| | hovering over a micro- | hovering over series | the cumulative number of |
| | data item type for the | thumbnails within the | seconds. Push into the |
| | past 3 months by the | micro-data item type | Personalized Feed in the |
| | medical professionals | “Study sharing | descending order after Rule #6 |
| | of first, second or | performed” by the | items have been processed |
| | third degree | medical professionals | |
| | connection | of first, second or third | |
| | | degree connection | |
| 8 | Number of seconds | Number of seconds | Rank all micro-data items types by |
| | medical professionals | medical professionals | the cumulative number of |
| | of first, second or | of first, second or third | seconds. Push into the |
| | third degree | degree connection | Personalized Feed in the |
| | connection stayed on | stayed on a series | descending order after Rule #7 |
| | a micro-data item | thumbnail within the | items have been processed |
| | type for the past 3 | micro-data item type | |
| | months | “Study sharing | |
| | | performed” | |

For rule one, the tracked interaction is a number of clicks, for example, on a particular micro-data item type over a first predetermined amount of time. With reference to FIGS. 10 and 11, an example of the tracked interaction for rule one is a number of clicks on “scanner” within the micro-data item type “scan started.” For example, the first predetermined amount of time is three months. Based on rule one, the second processor ranks all micro-data item types by a cumulative number of clicks. The second processor sorts the order based on the cumulative number of clicks, in descending order.

For rule two, the tracked interaction is a number of times a feature has been used by the user (e.g., the first user) for a second predetermined amount of time. For example, the second predetermined amount of time is three months. With reference to FIGS. 10 and 11, an example of the tracked interaction for rule two is a number of times a study is shared or a number of times a scan protocol has been exchanged by the user (e.g., the first user). Based on rule two, the second processor identifies all micro-data item types directly related to an object of a feature application (e.g., Study X, Study Y). The second processor pushes the micro-data items types directly related to the object of the feature application into the feed in an arbitrary order after the rule one micro-data item types have been processed.

For rule three, the tracked interaction is a number of seconds of hover over a micro-data item type over a third predetermined amount of time. For example, the third predetermined amount of time is three months. With reference to FIGS. 10 and 11, an example of the tracked interaction for rule three is a number of seconds hovering over series thumbnails within the micro-data item type “study sharing performed” by the user (e.g., the first user). Based on rule three, the second processor ranks all micro-data item types by the cumulative number of seconds. The second processor sorts the order based on the cumulative number of seconds, in descending order after the rule two micro-data item types have been processed.

For rule four, the tracked interaction is a number of seconds staying on a micro-data item type over a fourth predetermined amount of time. For example, the fourth predetermined amount of time is three months. With reference to FIGS. 10 and 11, an example of the tracked interaction for rule four is a number of seconds staying on a series thumbnail within the micro-data item type “study sharing performed.” Based on rule four, the second processor ranks all micro-data item types by the cumulative number of seconds. The second processor sorts the order based on the cumulative number of seconds, in descending order after the rule three micro-data item types have been processed.

For rule five, the tracked interaction is a number of clicks on a particular micro-data item type over a fifth predetermined amount of time. For example, the fifth predetermined amount of time is three months. With reference to FIGS. 10 and 11, an example of the tracked interaction for rule five is a number of clicks on “scanner” within the micro-data item type “scan started” by medical professionals of first, second, or third degree connections. Based on rule five, the second processor ranks all micro-data item types by a cumulative number of clicks. The second processor sorts the order based on the cumulative number of clicks, in descending order after the rule four micro-data item types have been processed.

For rule six, the tracked interaction is a number of times a feature has been used by the medical professionals, for example, of first, second, or third degree connections over a sixth predetermined amount of time. For example, the sixth predetermined amount of time is three months. With reference to FIGS. 10 and 11, an example of the tracked interaction for rule six is a number of times sharing a study for exchanging a scan protocol has been performed by the medical professionals of first, second, or third degree connection. Based on rule six, the second processor identifies all micro-data item types directly related to the object of the feature application (e.g., Study X, Protocol Y). The second processor pushes the micro-data items types into the feed in an arbitrary order after the rule five micro-data item types have been processed.

For rule seven, the tracked interaction is a number of seconds hovering over a micro-data item type over a seventh predetermined amount of time. For example, the seventh predetermined amount of time is three months. With reference to FIGS. 10 and 11, an example of the tracked interaction for rule seven is a number of seconds hovering over series thumbnails within the micro-data item type “study sharing performed” by, for example, the medical professionals of first, second, or third degree connection. Based on rule seven, the second processor ranks all micro-data item types by the cumulative number of seconds. The second processor sorts the order based on the cumulative number of seconds, in descending order after the rule six micro-data item types have been processed.

For rule eight, the tracked interaction is a number of seconds medical professionals of first, second, or third degree connection, for example, stayed on a micro-data item type over an eighth predetermined amount of time. For example, the eighth predetermined amount of time is three months. With reference to FIGS. 10 and 11, an example of the tracked interaction for rule eight is a number of seconds medical professionals of first, second, or third degree connection, for example, stayed on a series thumbnail within the micro-data item type “study sharing performed.” Based on rule eight, the second processor ranks all micro-data item types by the cumulative number of seconds. The second processor sorts the order based on the cumulative number of seconds, in descending order after the rule seven micro-data item types have been processed.

The second processor may sort the order based on the predefined rules listed in Table 2. The second processor may sort the order starting with the first rule and ending with the eighth rule (e.g., last rule). In one embodiment, sorting is performed using less than all of the rules of Table 2, additional rules, and/or different rules than listed in Table 2. In another embodiment, the second processor may sort the order based on a different order of the rules listed in Table 2. A table (e.g., Table 2), for example, may be stored in the memory of the computing device associated with the first user, for example, or another memory, and the second processor may sort the order based on the rules of the stored table. In one embodiment, the stored table is editable, such that an order in which the rules are applied may be changed and/or rules may be added or removed. The first, second, third, fourth, fifth, sixth, seventh, and eighth predetermined amounts of time may be the same amounts of time. Alternatively, one or more of the predetermined amounts of time may be different.

In one embodiment, the second processor first sorts the order based on predetermined rules corresponding to a role of the first user, then sorts the order based on previous interactions, as discussed above with reference to Table 2. In other words, the sorting of the order based on the role of the first user is performed before the sorting of the order based on the previous interactions by the first user.

The second processor may identify the role of the first user via, for example, stored data or an input by the first user, and may sort the order based on the identified role of the first user. For example, the memory of the computing device of the first user or another memory may store a table that includes the predetermined rules (e.g., rankings). The stored table may define different micro-data item types that may be displayed within the feed, different roles for the users, and rankings of the micro-data item types for the different roles. The second processor may compare the role for the first user to the stored table to determine how to perform the role-based sorting. The table may be editable by one or more of the users to add, remove, and/or change the roles, the micro-data item types, and/or the defined roles.

Table 3 illustrates an example of a table that stores predetermined sorting rules for different roles.

TABLE 3

| | Priority in Common Med Feed | | | |
|---|---|---|---|---|
| | (BEFORE Personalization) | | | |
| Micro-data item | User Role: | User Role: | User Role: | User Role: |
| type | Radiologist | Technologist | Executive | Admin |
| Scan started | 2 | 1 | 7 | 4 |
| Scan finished | 1 | 2 | 8 | 5 |
| Study sharing | 3 | 6 | 6 | 6 |
| performed | | | | |
| Protocol exchange | 5 | 3 | 4 | 1 |
| performed | | | | |
| Comment | 4 | 8 | 5 | 7 |
| Dose Alert | 7 | 4 | 1 | 3 |
| Utilization Alert | 8 | 5 | 2 | 2 |
| High Sharing | 6 | 7 | 3 | 8 |

As shown in the example of Table 3, the different micro-data item types, as discussed above with reference to FIGS. 10 and 11, are ranked for different roles. The roles may be predefined and may represent a majority of or all the users. For example, the roles may include radiologist, technologist, executive, and admin. Any number of other roles including, for example, doctor, may be included alternatively or additionally.

The rankings of the different micro-data item types determine how the different micro-data item types are sorted. In other words, the rankings determine where the different micro-data item types are located within the feed. As shown in the example of Table 3, for the radiologist role, the “scan finished” micro-data item type is ranked first and is moved to the top of the feed; the “utilization alert” micro-data item type is ranked eighth (e.g., last) and is moved to the bottom of the feed. For the technologist role, the “scan started” micro-data item type is ranked first and is moved to the top of the feed; the “comment” micro-data item type is ranked eighth and is moved to the bottom of the feed. For the executive role, the “dose alert” micro-data item type is ranked first and is moved to the top of the feed; the “scan finished” micro-data item type is ranked eighth and is moved to the bottom of the feed. For the admin role, the “protocol exchange performed” micro-data item type is ranked first and is moved to the top of the feed; the “high sharing” micro-data item type is ranked eighth and is moved to the bottom of the feed.

In one embodiment, the order is sorted every time the computing device associated with the first user is turned on and/or woken from sleep mode. In addition or alternatively, the order may be sorted once every predetermined time period such as, for example, thirty minutes. For example, the computing device receives, via the interface, one or more additional first datasets related to the one or more second users, one or more additional second datasets related to the one or more devices, or a combination thereof (e.g., additional transmitted data) after a first sorting. The additional transmitted data is displayed with the originally transmitted data, and the order is resorted based on at least the previous interactions by the first user.

FIG. 13 shows one embodiment of a system 1300 for obtaining a personalized medical feed. The system of FIG. 13 may represent runtime architecture for obtaining the personalized medical fee. The system 1300 includes hospitals 1302 and 1304 on the left side of FIG. 13 and a cloud system 1306 on the right side of FIG. 13 connected by (e.g., in communication with) a network 1308. The network 1308 may, for example, be the Internet. The system 1300 may include more, fewer, and/or different components. For example, the system 1300 may include more hospitals in communication with the cloud system 1306.

Each of the hospitals 1302 and 1304 includes a computing device (e.g., a data sending component). The computing device includes a processor (e.g., the second processor), a memory, and an interface via which communications are sent and received. The computing device (e.g., the processor of the computing device) connects with other components within the respective hospital 1302, 1304. For example, the computing device connects with picture archiving and communication systems (PACSs) and scanners within the respective hospital 1302, 1304. The computing device identifies and obtains (e.g., receives), for example, imaging studies and/or related information (e.g., data) for the micro-data items to be displayed within the personalized medical feed.

Act 1310 includes transmission of the data obtained by the computing devices of the hospitals 1302, 1304, respectively, from the hospitals 1302, 1304 to the cloud system 1306 via the Internet 1308. The computing devices of the hospitals 1302, 1304 store the data obtained by the computing devices in one or more storage devices 1312 within the cloud system 1306. The one or more storage devices 1312 may be, for example, memory of one or more servers, for example.

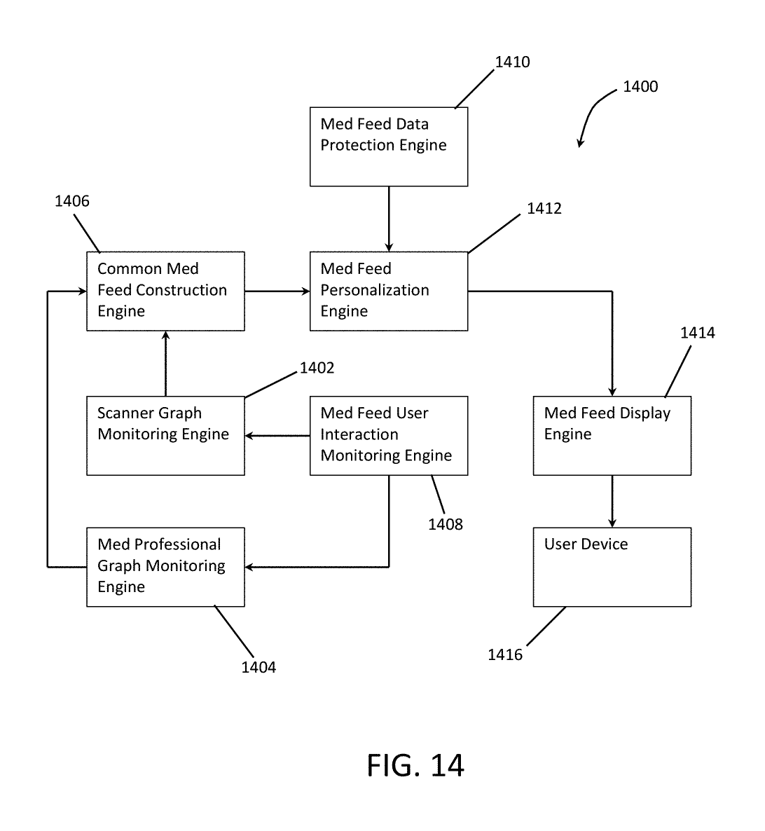

In act 1314, a data processor 1316 (e.g., the first processor) of the cloud system 1306 parses the data obtained by the computing devices of the hospitals 1302, 1304. In act 1318, the data processor 1316 creates an index of the data in a database 1322 of the cloud system 1306. An application frontend 1324 may be used by the user of one of the computing devices (e.g., the first user). The application frontend 1324 may run on any device and at any location. In act 1326, the application frontend 1324 communicates with an application backend 1328. The application backend 1328 runs in the cloud system 1306. Once a request for a personalized medical feed is received by the application backend 1328 in act 1326, the application backend 1328 connects with a medical feed personalization engine 1330 (discussed below) in act 1332. The medical feed personalization engine 1330 may be software and/or hardware. For example, the medical feed personalization engine 1330 is a programmed controller (e.g., the data processor 1316). The medical feed personalization engine 1330 works with all other components discussed below with reference to FIG. 14. In one embodiment, the medical feed personalization engine 1330 makes use of a REST-based data access web service 1334 in act 1332.

FIG. 14 shows one embodiment of components of a system 1400 for obtaining a personalized medical feed. The components of the system 1400 may be hardware components (e.g., one or more processors and memory) and/or software components executed by a processor. For example, one or more of the computing devices of the hospitals 1302, 1304, the one or more storage devices 1312 within the cloud system 1306, the data processor 1316 of the cloud system 1306, and/or the database 1322 of the cloud system 1306 form or run at least some of the components of the system 1400 shown in FIG. 14.

The system 1400 includes a scanner graph monitoring engine 1402. The scanner graph monitoring engine 1402 constructs, monitors, and maintains scanner graphs. The scanner graph monitoring engine 1402 maintains links for the first, second, and third degree connections. The scanner graphs are stored in cloud storage and are made available for programmatic consumption by, for example, a scalable REST-based public application program interface (API), for example.

The system 1400 also includes a medical professional graph monitoring engine 1404. The medical professional graph monitoring engine 1404 constructs, monitors, and maintains medical professional graphs. The medical professional graph monitoring engine 1404 maintains links for the first, second, and third degree connections. The medical professional graphs are stored in cloud storage and are made available for programmatic consumption by the scalable REST-based public API, for example.

The system 1400 includes a medical feed construction engine (e.g., a common medical feed construction engine) 1406. The medical feed construction engine 1406 constructs the medical feed. In one embodiment, the medical feed construction engine 1406 sorts the first, second and third degree connected micro-data items based on a role of the user (e.g., the first user).

The system 1400 also includes a medical feed user interaction engine 1408. The medical feed user interaction engine 1408 monitors and tracks all the user interactions for all user roles and each of the first, second, and third degree connections for each of the users. The user interaction data is stored in cloud storage and is made available for programmatic consumption by the scalable REST-based public API, for example.

The system 1400 includes a medical feed data protection engine 1410. The medical feed data protection engine 1410 provides input on whether to include a micro-data item into the personalized medical feed. In one embodiment, the medical feed data protection engine 1410 provides input on whether to include the micro-data item into the personalized medical feed based on data protection model discussed above.

The system 1400 also includes a medical feed personalization engine 1412. The medical feed personalization engine 1412 constructs the personalized medical feed based on previous user interactions. In one embodiment, the medical feed personalization engine 1412 conducts an interaction history-based sort, within the medical feed, of micro-data items related to the user (e.g., the first user) and micro-data items related to first, second, and third degree connections of the user.

The system 1400 includes a medical feed display engine 1414. The medical feed display engine 1414 prepares rendering of the personalized medical feed to a user device (e.g., a workstation). In one embodiment, the medical feed display engine 1414 provides the rendering to the user device with a specific form factor and current Internet connectivity.

The system 1400 also includes a user device 1416. The user device 1416 may be any number of computing devices including, for example, a laptop computer or a desktop computer (e.g., a workstation).

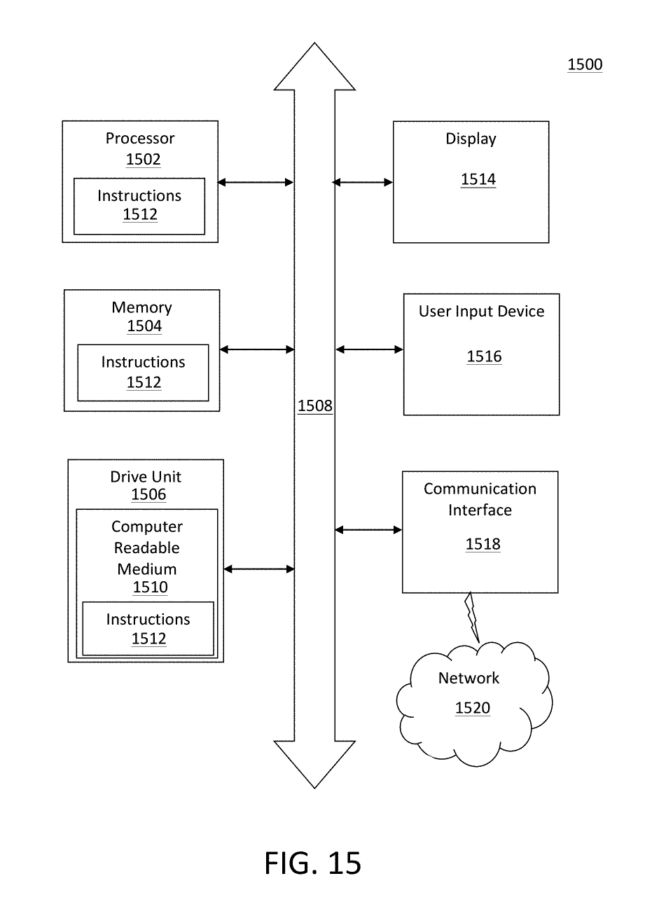

FIG. 15 shows an illustrative embodiment of a general computer system 1500. The computer system 1500 may include a set of instructions that may be executed to cause the computer system 1500 to perform any one or more of the methods or computer based functions disclosed herein. The computer system 1500 may operate as a standalone device or may be connected (e.g., using a network) to other computer systems or peripheral devices. Any of the components discussed above may be a computer system 1500 (e.g., the user device 1416) or a component in the computer system 1500.

In a networked deployment, the computer system 1500 may operate in the capacity of a server or as a client user computer in a client-server user network environment, or as a peer computer system in a peer-to-peer (or distributed) network environment. The computer system 1500 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a control system, a personal trusted device, a web appliance, a network router, switch or bridge, or any other machine capable of executing a set of instructions (sequential or otherwise) that specify actions to be taken by that machine. In one embodiment, the computer system 1500 may be implemented using electronic devices that provide video or data communication. Further, while a single computer system 1500 is illustrated, the term “system” shall also be taken to include any collection of systems or sub-systems that individually or jointly execute a set, or multiple sets, of instructions to perform one or more computer functions.

As illustrated in FIG. 15, the computer system 1500 may include a processor 1502 such as, for example, a central processing unit (CPU), a graphics-processing unit (GPU), or both. The processor 1502 may be a component in a variety of systems. For example, the processor 1502 may be part of a standard personal computer or a workstation. The processor 1502 may be one or more general processors, digital signal processors, application specific integrated circuits, field programmable gate arrays, servers, networks, digital circuits, analog circuits, combinations thereof, or other now known or later developed devices for analyzing and processing data. The processor 1502 may implement a software program, such as code generated manually (i.e., programmed).

The computer system 1500 may include a memory 1504 that may communicate via a bus 1508. The memory 1504 may be representative of the database 1522. The memory 1504 may be a main memory, a static memory, or a dynamic memory. The memory 1504 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 1504 includes a cache or random access memory for the processor 1502. In alternative embodiments, the memory 1504 is separate from the processor 1502, such as a cache memory of a processor, the system memory, or other memory. The memory 1504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1504 is operable to store instructions executable by the processor 1502. The functions, acts or tasks illustrated in the figures or described herein may be performed by the programmed processor 1502 executing the instructions stored in the memory 1504. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1500 may further include a display unit 1514, such as a liquid crystal display (LCD), an organic light emitting diode (OLED), a flat panel display, a solid state display, a cathode ray tube (CRT), a projector, a printer or other now known or later developed display device for outputting determined information. The display 1514 may act as an interface for the user to see the functioning of the processor 1502, or specifically as an interface with the software stored in the memory 1504 or in a disk or optical drive unit 1506 (e.g., a disk drive unit).

Additionally, the computer system 1500 may include an input device 1516 configured to allow a user to interact with any of the components of system 1500. The input device 1516 may be a number pad, a keyboard, or a cursor control device, such as a mouse, or a joystick, touch screen display, remote control or any other device operative to interact with the system 1500.

In one embodiment, as depicted in FIG. 15, the computer system 1500 may also include the disk or optical drive unit 1506. The disk drive unit 1506 may include a computer-readable medium 1510, in which one or more sets of instructions 1512 (e.g., software) may be embedded. Further, the instructions 1512 may embody one or more of the methods or logic as described herein. In one embodiment, the instructions 1512 may reside completely, or at least partially, within the memory 1504 and/or within the processor 1502 during execution by the computer system 1500. The memory 1504 and the processor 1502 also may include computer-readable media as discussed above.

The present disclosure contemplates a computer-readable medium that includes instructions 1512 or receives and executes instructions 1512 responsive to a propagated signal, so that a device connected to a network 1520 may communicate voice, video, audio, images or any other data over the network 1520. Further, the instructions 1512 may be transmitted or received over the network 1520 via a communication port 1518. The communication port 1518 may be a part of the processor 1502 or may be a separate component. The communication port 1518 may be created in software or may be a physical connection in hardware. The communication port 1518 is configured to connect with the network 1520 or another network, external media, the display 1514, any other components in system 1500, or combinations thereof. The connection with the network 1520 may be a physical connection, such as a wired Ethernet connection or may be established wirelessly as discussed below. Likewise, the additional connections with other components of the system 1500 may be physical connections or may be established wirelessly.

The network 1520 may include wired networks, wireless networks, or combinations thereof, and may be representative of the network 1308. The wireless network may be a cellular telephone network, an 802.11, 802.16, 802.20, or WiMax network. Further, the network 1520 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media (e.g., a centralized or distributed database and/or associated caches and servers that store one or more sets of instructions). The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In one embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limiting embodiment, implementations may include distributed processing, component/object distributed processing, and parallel processing. Alternatively, virtual computer system processing may be constructed to implement one or more of the methods or functionality as described herein.

The methods and systems of the present embodiments provide a number of advantages compared to the prior art. For example, medical information representation using a continuous feed of simple micro-data (e.g., small portions of information) aids in the speed of information processing. The micro-data items inside the feed are ordered according to previous user interactions with the feed (e.g., by the current user and by connections of the current user of the first, second, and third degree). Most interacted with micro-data item types are pushed to the top of the feed. In this way, the medical information is presented to the user in the easiest way for consumption (e.g., micro-data) with the continuously most relevant items on the top of the feed.

The time the user needs to get to the right information, compared to feature search functions in the prior art systems, for example, and the time the user needs to process the information, compared to the interpretation of complex graphs and charts of the prior art systems, may be reduced.

The micro-data items in the feed include items of the current user and items of first, second, and third degree connections to the current user, for example. All of the micro-data items in the feed are sorted twice: first, by the role-based priorities of a common medical feed construction engine, which differ for, for example, radiologists, technologists, executives, and administrators; and second, by the interaction-history-based priorities of the medical feed personalization engine. The methods and systems of the present embodiments predict the importance of micro-data items to the user based on the actions that the user and connections of the user have taken in response to being shown previous feeds on previous log-ons. New interaction data is continuously fed into the process of feed construction, and thus, the relevance of data in the feed is also improved on a continuous basis.

The data about patient image studies, radiation dose, scanner utilization, scanner protocols, image sharing, and other data are presented in a way that takes into account previous social interactions with the data. The data is displayed in an order of significance according to the previous social interactions with the data. The ease with which the user may process a large amount of data may be increased. The time needed to process a large amount of data on a daily basis may be reduced, and the data may be represented in a way that is optimized to previous social interactions in nearly real time.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method of identifying data to be displayed to a first user, the method comprising:
storing, by a memory, connections between users and devices, the users comprising the first user and being associated with first properties, the devices being associated with second properties;
identifying, by a processor in communication with the memory, a first connection, a second connection, or the first connection and the second connection from the stored connections based on the first user, the first connection being between the first user and a second of the users, the second connection being between the first user and a first of the devices, the first connection indicating one of the first properties for the first user matches the one first property for the second user, the second connection indicating the one first property or another of the first properties for the first user matches one of the second properties for the first device; and
identifying the data to be displayed to the first user based on the identified first connection, the identified second connection, or the identified first connection and the identified second connection.

2. The method of claim 1, wherein identifying the data to be displayed comprises identifying data related to the one first property, data related to the one second property, or a combination thereof.

3. The method of claim 2, wherein the devices are medical imaging devices,
wherein the first properties comprise an institution, a department, a role, and images, and
wherein the second properties comprise an institution, a department, a type of medical imaging device, protocols installed at the medical imaging device, dose values, a modality type, images, and utilization of the medical imaging device.

4. The method of claim 1, further comprising:
generating a first graphical representation for each of the users, each of the first graphical representations identifying the first properties for the respective user;
generating a second graphical representation for each of the devices, each of the second graphical representations identifying the second properties for the respective device; and
identifying the connections between the users and the devices, the identifying of the connections between the users and the devices comprising identifying property matches between the users and the devices.

5. The method of claim 4, wherein identifying the property matches between the users and the devices comprises:
comparing, for each of the users, the first properties for the user to the first properties for the other users;
comparing, for each of the devices, the second properties for the device to the second properties for the other devices; and
comparing, for each of the users, the first properties for the user to the second properties for the devices.

6. The method of claim 5, wherein the second properties comprise dose values and utilization of the device,
wherein comparing, for each of the devices, the second properties for the device to the second properties for the other devices comprises:
determining a first subset of the devices for which dose values are within a first percentage of dose values of the device; and
determining a second subset of the devices for which utilization of the device is within a second percentage of utilization of the device, and
wherein at least a first portion of the identified data to be displayed is related to the first subset of the devices, and at least a second portion of the identified data to be displayed is related to the second subset of the devices.

7. The method of claim 1, further comprising transmitting the identified data to be displayed to a computing device associated with the first user.

8. A method of displaying data to a first user, the first user being associated with first properties, the method comprising:
receiving, by an interface, one or more first datasets related to one or more second users, one or more second datasets related to one or more devices associated with second properties, or the one or more first datasets and the one or more second datasets, the one or more first datasets being data related to first properties of the one or more second users that match a first subset of the first properties for the first user, respectively, the one or more second datasets being data related to second properties of the one or more devices that match a second subset of the first properties for the first user, respectively;
displaying, by a display in communication with the interface, a subset of the one or more first datasets, the one or more second datasets, or the one or more first datasets and the one or more second datasets in an order; and
sorting, by a processor in communication with the display, the order based on previous interactions by the first user, via an input device in communication with the display, with data displayed by the display.

9. The method of claim 8, wherein the one or more devices are one or more first devices,
wherein the method further comprises:
receiving, by the interface, one or more third datasets related to one or more third users, the one or more third datasets being data related to first properties of the one or more third users that match first properties of the one or more second users;
receiving, by the interface, one or more fourth datasets related to one or more second devices, the one or more fourth datasets being data related to second properties of the one or more second devices that match second properties of the one or more first devices;
receiving, by the interface, one or more fifth datasets related to at least one of the first devices, at least one of the second users, or the at least one first device and the at least one second user, the one or more fifth datasets being data related to second properties of the at least one first device that match first properties of the at least one second user, first properties of the at least one second user that match second properties of the at least one first device, or a combination thereof; or
any combination thereof, and
wherein the displaying comprises displaying, by the display, the one or more first datasets, the one or more second datasets, the one or more third datasets, the one or more fourth datasets, the one or more fifth datasets, or any combination thereof in the order.

10. The method of claim 8, wherein at least one dataset of the one or more displayed first datasets, the one or more displayed second datasets, or the one or more displayed first datasets and the one or more displayed second datasets includes a selectable hyperlink, the selectable hyperlink being linked to additional data related to the at least one dataset,
wherein the method further comprises:
monitoring the input device; and
storing, by a memory in communication with the processor, data related to selection of the selectable hyperlink by the input device, and
wherein the sorting comprises sorting, by the processor, the order based on the stored data related to the selection.

11. The method of claim 8, further comprising sorting, by the processor, the order based on predetermined rules corresponding to a role of the first user, the sorting of the order based on the role of the first user being performed before the sorting of the order based on the previous interactions by the first user.

12. The method of claim 8, wherein the order is a first order, and
wherein the method further comprises:
receiving, by the interface, one or more additional first datasets related to the one or more second users, one or more additional second datasets related to the one or more devices, or the one or more additional first datasets and the one or more additional second datasets after the sorting; and
displaying the one or more additional first datasets, the one or more additional second datasets, or the one or more additional first datasets and the one or more additional second datasets with the one or more first datasets, the one or more second datasets, or the one or more first datasets and the one or more second datasets in a second order; and
resorting, by the processor, the second order based on the previous interactions by the first user.

13. The method of claim 8, wherein sorting the order comprises sorting the order once every predetermined time period.

14. The method of claim 8, further comprising:
identifying a location of the first user;
identifying locations of origin of the one or more first datasets, the one or more second datasets, or the one or more first datasets and the one or more second datasets, respectively;
comparing the location of the first user to the locations of origin of the one or more first datasets, the one or more second datasets, or the one or more first datasets and the one or more second datasets, respectively; and
determining the subset of the one or more first datasets, the one or more second datasets, or the one or more first datasets and the one or more second datasets based on the comparison.

15. The method of claim 14, wherein the determined subset comprises all of the one or more first datasets, the one or more second datasets, or the one or more first datasets and the one or more second datasets based on the comparison.

16. An apparatus for identifying data to be displayed to a user, the apparatus comprising:
a memory configured to store connections between users and devices, the users comprising the first user and being associated with first properties, the devices being associated with second properties; and
a processor in communication with the memory, the processor being configured to:
identify a first connection and a second connection from the stored connections based on the first user, the first connection being between the first user and a second of the users, the second connection being between the first user and a first of the devices, the first connection indicating one of the first properties for the first user matches the one first property for the second user, the second connection indicating the one first property or another of the first properties for the first user matches one of the second properties for the first device; and
identify the data to be displayed to the first user based on the identified first connection and the identified second connection.

17. The apparatus of claim 16, the devices are medical imaging devices,
wherein the first properties comprise an institution, a department, a role, and images, and
wherein the second properties comprise an institution, a department, a type of medical imaging device, protocols installed at the medical imaging device, dose values, a modality type, images, and utilization of the medical imaging device.

18. The apparatus of claim 16, wherein the processor is further configured to:
generate a first graphical representation for each of the users, each of the first graphical representations identifying the first properties for the respective user;
generate a second graphical representation for each of the devices, each of the second graphical representations identifying the second properties for the respective device; and
identify the connections between the users and the devices, the identifying of the connections between the users and the devices comprising identifying property matches between the users and the devices.

19. An apparatus for displaying data to a first user, the first user being associated with first properties, the apparatus comprising:
an interface configured to receive one or more first datasets related to one or more second users, one or more second datasets related to one or more devices associated with second properties, or the one or more first datasets and the one or more second datasets, the one or more first datasets being data related to first properties of the one or more second users that match a first subset of the first properties for the first user, respectively, the one or more second datasets being data related to second properties of the one or more devices that match a second subset of the first properties for the first user, respectively;
a display in communication with the interface, the display being configured to display a subset of the one or more first datasets, the one or more second datasets, or the one or more first datasets and the one or more second datasets in an order; and
a processor in communication with the display, the processor being configured to sort the order based on previous interactions by the first user, via an input device in communication with the display, with data displayed by the display.

20. The apparatus of claim 19, wherein the one or more devices are one or more first devices,
wherein the interface is further configured to:
receive one or more third datasets related to one or more third users, the one or more third datasets being data related to first properties of the one or more third users that match first properties of the one or more second users;
receive one or more fourth datasets related to one or more second devices, the one or more fourth datasets being data related to second properties of the one or more second devices that match second properties of the one or more first devices;
receive one or more fifth datasets related to at least one of the first devices, at least one of the second users, or the at least one first device and the at least one second user, the one or more fifth datasets being data related to second properties of the at least one first device that match first properties of the at least one second user, first properties of the at least one second user that match second properties of the at least one first device, or a combination thereof; or
any combination thereof, and
wherein the display is configured to display the one or more first datasets, the one or more second datasets, the one or more third datasets, the one or more fourth datasets, the one or more fifth datasets, or any combination thereof in the order.
